(19) United States
(12) Patent Application Publication
(10) Pub. No.: US 2019/0004314 A1
(43) Pub. Date: Jan. 3, 2019

(54) HEAD-UP DISPLAY FOR VEHICLE

(71) Applicant: KYOCERA Corporation, Tokyo (JP)

(72) Inventors: Yusuke HAYASHI, Fort Lee, NJ (US); Kaoru KUSAFUKA, Setagaya-ku, Tokyo (JP); Satoshi KAWAJI, Yokohama-shi, Kanagawa (JP)

(73) Assignee: KYOCERA Corporation, Kyoto (JP)

(21) Appl. No.: 16/072,276

(22) PCT Filed: Jan. 27, 2017
(86) PCT No.: PCT/JP2017/003015

§ 371 Date: Jul. 24, 2018

(30) Foreign Application Priority Data
Jan. 27, 2016 (JP) 2016-013851

(51) Int. Cl. G02B 27/01; B60K 35/00; B60K 37/02

(52) U.S. Cl. CPC G02B 27/0101; B60K 35/00; B60K 37/02; B60K 2350/92; B60K 2350/1072; B60K 2350/2052; G02B 2027/0118

(57) ABSTRACT

A head-up display for a vehicle includes a light source, a display panel, and an illumination optical system. The display panel is of a transmissive type. The illumination optical system guides illumination light from the light source to the display panel. The illumination optical system includes a lens module. The lens module includes one or more lenses positioned on an optical axis of the illumination light. The light source is configured to emit the illumination light in which beams forming a larger angle with respect to the optical axis have lower brightness. The lens module has an optical property whereby, in the illumination light beams which form a larger angle with respect to the optical axis are transmitted with increased density.

### CROSS REFERENCE TO RELATED APPLICATION

This application claims priority to and the benefit of Japanese Patent Application No. 2016-13851 (filed on Jan. 27, 2016), the entire contents of which are incorporated herein by reference.

### TECHNICAL FIELD

The present disclosure relates to a head-up display for a vehicle.

### BACKGROUND

A head-up display for a vehicle reflects light that has passed through a light-transmitting liquid crystal panel or the like on to a windshield of the vehicle. The reflected light forms a virtual image to be viewed by an operator of the vehicle.

A head-up display may suffer from uneven brightness in the virtual image. As such, techniques for reducing uneven brightness caused by a head-up display for a vehicle have been proposed. For example, JP-A-2011-90217 discloses a technique for reducing uneven brightness in the virtual image. In the technique disclosed in JP-A-2011-90217, a plurality of light sources is provided. A plurality of lenses is arranged in correspondence with the plurality of light sources. The central axis of emitted light from a lens positioned on an outer side is oriented in a direction to the outer side.

### SUMMARY

A head-up display for a vehicle according to an embodiment of the present disclosure includes a light source, a display panel, and an illumination optical system. The display panel is of a transmissive type. The illumination optical system guides illumination light from the light source to the display panel. The illumination optical system includes a lens module. The lens module includes one or more lenses positioned on an optical axis of the illumination light. The light source is configured to emit the illumination light in which beams forming a larger angle with respect to the optical axis have lower brightness. The lens module has an optical property whereby, in the illumination light beams which form a larger angle with respect to the optical axis are transmitted with increased density.

### BRIEF DESCRIPTION OF THE DRAWINGS

In the accompanying drawings:

FIG. 1 is a diagram illustrating a schematic configuration of a head-up display for a vehicle according to an embodiment of the present disclosure;

FIG. 2 is a diagram illustrating a schematic configuration of a display of FIG. 1;

FIG. 3 is a diagram illustrating a schematic configuration of the display of FIG. 1;

FIG. 4 is a diagram illustrating an enlarged view of a part of the display;

FIG. 5 is a diagram illustrating a schematic configuration of a variation of the display of FIG. 1; and

FIG. 6 is a diagram illustrating a schematic configuration of another variation of the display of FIG. 1.

### DETAILED DESCRIPTION

Hereinafter, embodiments of the present disclosure will be described in detail with reference to the drawings.

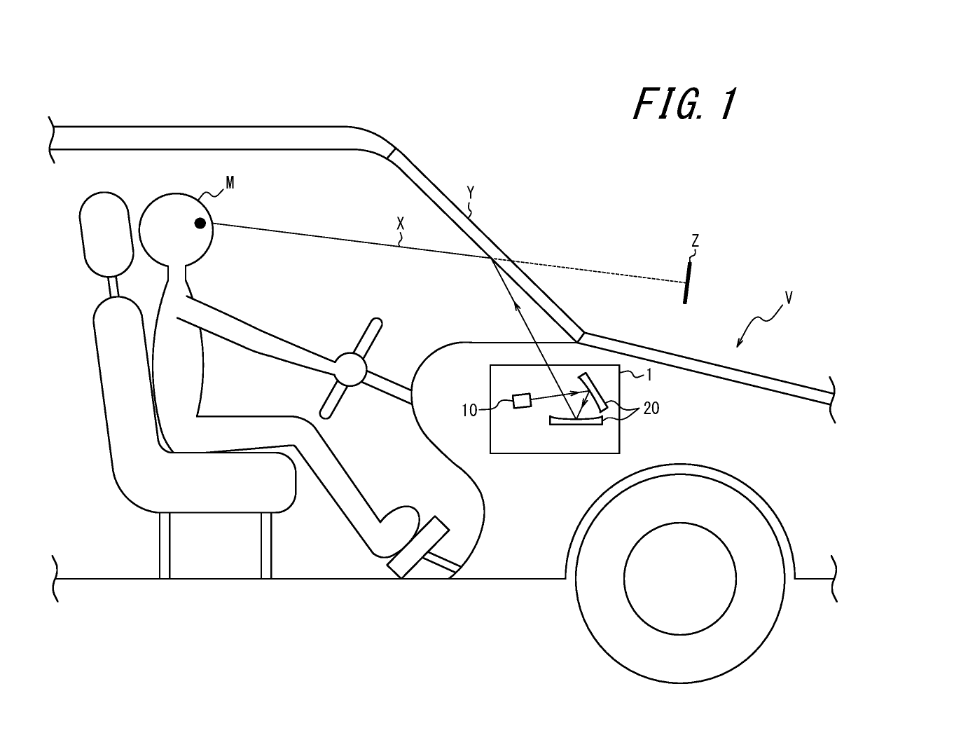

Referring to FIG. 1, a schematic configuration of a head-up display 1 for a vehicle according to an embodiment of the present disclosure will be described. The head-up display 1 for a vehicle includes a display 10 and a projection optical system 20. The head-up display 1 for a vehicle is accommodated in, for example, a dashboard of a vehicle V.

The display 10 emits display light X to the outside of the head-up display 1 for a vehicle via the projection optical system 20. The display light X is reflected by a semi-transmissive plate Y such as the windshield of the vehicle V. The reflected display light X is incident on the eyes of an operator (a driver or the like) M of the vehicle V. The display light X incident on the eyes of the operator M as described above forms a virtual image Z visible to the operator M at a certain position in front of the semi-transmissive plate Y.

The display 10 includes a light source and a transmissive display panel. Illumination light emitted from the light source passes through the transmissive display panel. After passing through the display panel, the illumination light exits the display 10. When passing through the display panel, the intensity of each wavelength of the illumination light is attenuated in accordance with a requested image. The illumination light forms the display light X by passing through the display panel. The display 10 will be described in detail later.

The projection optical system 20 guides the display light X from the display 10 to the semi-transmissive plate Y. The projection optical system 20 is capable of increasing an extent over which the display light X is projected. The projection optical system 20 includes, for example, a mirror such as a concave mirror. Although FIG. 1 illustrates the projection optical system 20 provided with two mirrors, the number of mirrors is not limited to two.

The semi-transmissive plate Y may reflect a portion of incident light. The semi-transmissive plate Y may transmit a portion of the incident light. The semi-transmissive plate Y may be provided to the vehicle V. The semi-transmissive plate Y may be, other than the windshield of the vehicle V, a combiner or the like for reflecting the display light X. The semi-transmissive plate Y configured as the combiner or the like may be included in the head-up display 1 for a vehicle. The semi-transmissive plate Y reflects a portion of the display light X emitted from the head-up display 1 for a vehicle. The semi-transmissive plate Y reflects the display light X to a space in which the eyes of the operator M are assumed to exist.

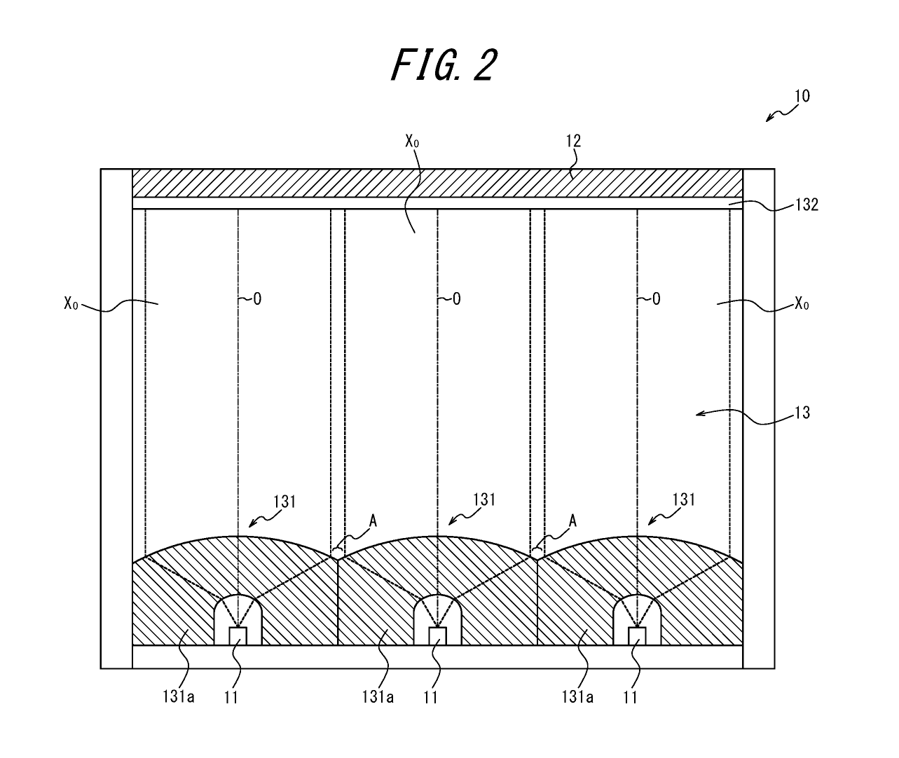

Referring to FIG. 2, a schematic configuration of the display 10 will be described. The display 10 includes a light source 11, a display panel 12, and an illumination optical system 13.

The light source 11 is a member for emitting an illumination light X₀. The light source 11 includes, for example, one or more light emitting elements such as one or more LEDs (Light Emitting Diodes) for emitting white light in a diffusive manner. The light source 11 may be positioned on a substrate parallel to the display panel 12. In the example of FIG. 2, three light sources 11 are positioned on the substrate. The illumination light X₀ emitted from each of the light sources 11 passes through the illumination optical system 13 and irradiates the display panel 12. Here, each of the light sources 11 may be configured with one light emitting element. Each of the light sources 11 may include a plurality of light emitting elements which can be regarded as a point light source. In each of the light sources 11, a plurality of light emitting elements may be arranged in close proximity to one another. The illumination light X₀ emitted from each of the light sources 11 has a brightness distribution. In the brightness distribution, the beam in a direction of an optical axis O has the highest brightness and the brightness of beams decreases as the angle formed with respect of the optical axis O increases. The optical axis O of the light source 11 may be regarded as a direction in which the brightness of the illumination light X₀ is the highest.

The display panel 12 is a display panel of a transmissive type. The display panel 12 includes a liquid crystal display panel or an MEMS shutter panel. The liquid crystal display panel may include, for example, a polarizing filter, a glass substrate, a transparent electrode, an alignment film, a liquid crystal display element, a color filter, etc. When the illumination light X₀ is emitted from the light source 11 via the illumination optical system 13, the display panel 12 transmits the illumination light X₀ passing therethrough as the display light X. The display light X corresponds to the image displayed on the display panel 12. When a color image is displayed on the display panel 12, the display light X corresponds to the color image. When the image displayed on the display panel 12 changes, the display light X changes accordingly.

The illumination optical system 13 is positioned between each of the light sources 11 and the display panel 12. The illumination optical system 13 guides the illumination light X₀ from the light source 11 to the display panel 12. The illumination optical system 13 includes a lens module 131 and a diffuser plate 132.

The lens module 131 is arranged opposite the light sources 11. The lens module 131 is configured to render the illumination light X₀ into substantially collimated light with a uniform brightness distribution. The lens module 131 includes a lens 131a. The lens 131a is positioned on the optical axis O of the illumination light X₀ from the light sources 11. The illumination light X₀ is rendered into substantially collimated light by a plurality of lens modules 131.

The surface facing the display panel 12 of each of the lenses 131a is relatively rough in peripheral portions A that are close to other lenses, as compared to a central area. The illumination light X₀ emitted from the lens 131a is diffused by the rough surface. The rough surface of each of the lenses 131a may be formed by a surface roughening treatment. The surface roughening treatment may include, for example, satin finish or random uneven pattern formation on the surface of the lens 131a. The surface roughening treatment may impart a light diffusion effect to the lens 131a. Roughening the peripheral portions A of the lens 131a enables the lens module 131 to reduce the occurrence of moiré fringes and color shift.

The diffuser plate 132 is provided so as to cover a surface of the display panel 12 facing the light source 11. The diffuser plate 132 transmits the illumination light X₀ from the lens module 131 to the display panel 12 by diffusing the illumination light X₀.

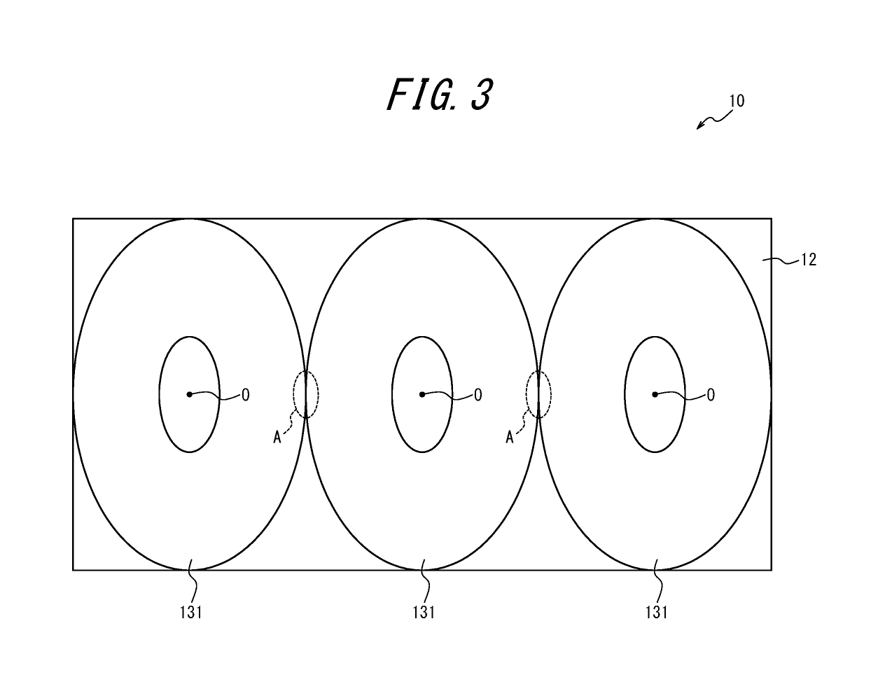

Referring to FIG. 3, a configuration of the display 10 when the light source 11 is viewed from the display panel 12 will be described. Each of the lens modules 131 is formed with an elliptical shape having a curvature for covering across a wide area of the display panel 12, which serves as an illuminated surface on a plane perpendicular to the optical axis O of the illumination light X₀. This shape enables the lens module 131 to irradiate a wide area of the display panel 12 with the illumination light X₀.

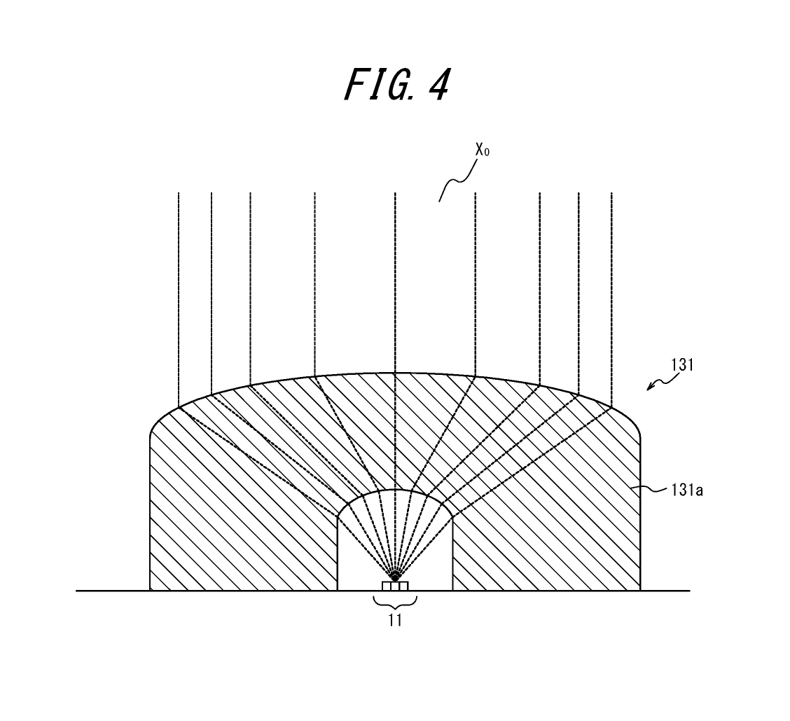

Next, referring to FIG. 4, the manner by which each of the plurality of lens modules 131 renders the illumination light X₀ₐₙ into substantially collimated light with a uniform intensity distribution will be described. FIG. 4 illustrates an enlarged view of one of the lens modules 131 and the light source 11 corresponding to the lens module 131. In the example illustrated in FIG. 4, the light source 11 is configured with three light emitting elements arranged side by side. The broken lines illustrated in FIG. 4 represent paths of nine beams emitted at equal angular intervals from the light sources 11 among the beams of the illumination light X₀.

The lens 131a included in the lens module 131 includes a concave surface facing the light source 11. The lens 131a includes a convex surface facing the display panel 12. The lens 131a is a meniscus lens having a positive lens power. The illumination light X₀ from the light source 11 is incident on the concave surface of the lens 13a of the lens module 131. When incident on the concave surface of the lens 131a, the illumination light X₀ is refracted in a direction in which the inclination angle with respect to the optical axis O increases, and then travels in the direction of the convex surface. The smaller the angle formed by a beam of the illumination light X₀ with respect to the optical axis O, the stronger the refraction of the beam. The illumination light X₀ is rendered into substantially collimated light when passing through the convex surface. The illumination light X₀ is refracted by the interface of the convex surface and thus rendered into substantially collimated light. Among the beams transmitted as the substantially collimated light, beams located on an outer side are more concentrated than beams located an inner side closer to the optical axis O. That is, the lens module 131 has an optical property whereby, in the illumination light X₀ from the light source 11, beams which form a larger angle with respect to the optical axis are transmitted with increased density.

The illumination light X₀ from the light source 11 has a brightness distribution in which beams forming a larger angle with respect to the optical axis O have lower brightness. In the illumination light X₀, beams with lower brightness are converted into a light with higher density. The illumination light X₀ is rendered as light with a uniform brightness distribution by matching the brightness distribution of the light source 11 and the optical property of the lens module 131.

As described above, the lens module 131 has an optical property whereby, in the illumination light X₀, beams which form a larger angle with respect to the optical axis are transmitted with increased density. The optical property of the lens module 131 may be realized by, for example, continuously changing the curvature of the concave surface of the lens 131a included in the lens module 131 in accordance with its position. For example, the optical property may be realized when the lens 131a included in the lens module 131 has a refractive index distribution in which the refractive index increases away from the optical axis O. Giving the lens 131a a refractive index distribution may be realized by, for example, continuously changing a composition of the lens 131a in accordance with the distance from the optical axis O.

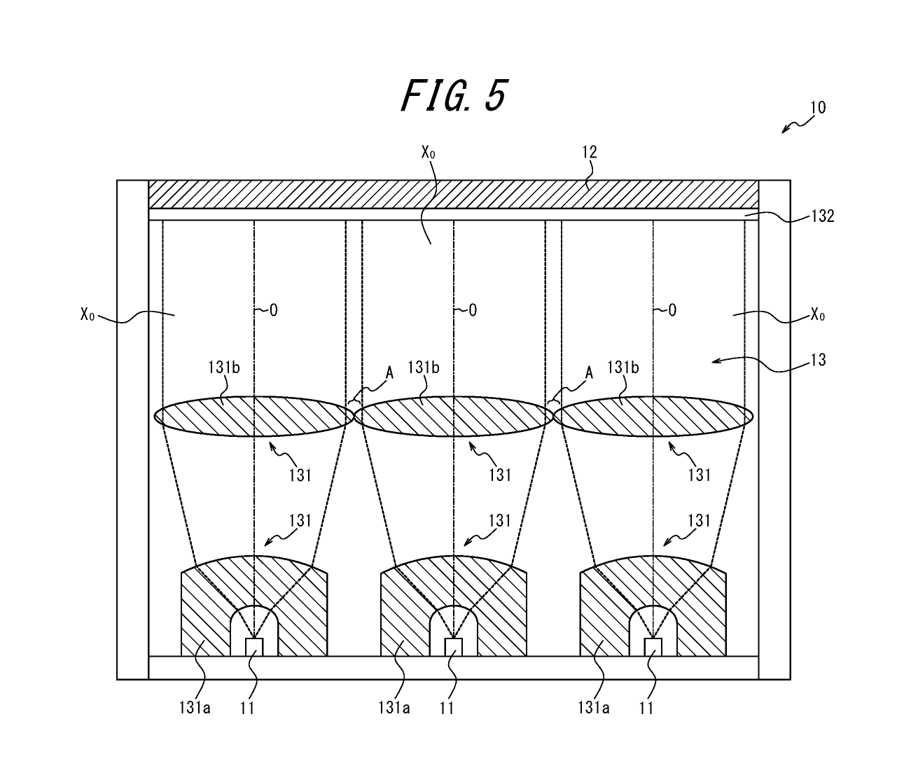

Referring to FIG. 5, a schematic configuration of a variation of the display 10 will be described. In the display 10, the lens module 131 may include a plurality of lenses positioned on the optical axis O of the illumination light X₀. In this case, the lens module 131 includes one or more lenses having a concave surface facing the light source 11 and one or more lenses having a convex surface facing the display panel 12. In the example illustrated in FIG. 5, the lens module 131 includes two lenses. The lens 131a positioned close to the light source 11 is a meniscus lens having a concave surface facing the light source 11 and a convex surface facing the display panel 12 and has a positive lens power. The lens 131b positioned close to the display panel 12 is a biconvex lens having a convex surface facing the light source 11 and a convex surface facing the display panel 12. Each of the lenses 131b, similarly to the lenses 131a of the above embodiment, includes peripheral portions A close to other lenses and subjected to the surface roughening treatment. The illumination light X₀ transmitted through the lens 131b is diffused due to the rough surface treatment.

The illumination light X₀ from the light source 11 enters the concave surface of the lens 131b positioned close to the light source 11. When entering the concave surface of the lens 131b, the illumination light X₀ is refracted in a direction forming a large inclination angle with respect to the optical axis O and then travels to the convex surface. When passing through the convex surface, the illumination light X₀ is refracted stepwise by the convex surface and the lens 131b positioned close to the display panel 12 and rendered into substantially collimated light. In a manner similar to the example illustrated in FIG. 4, the brightness distribution of the illumination light X₀ is brought close to uniform by the lens module 131.

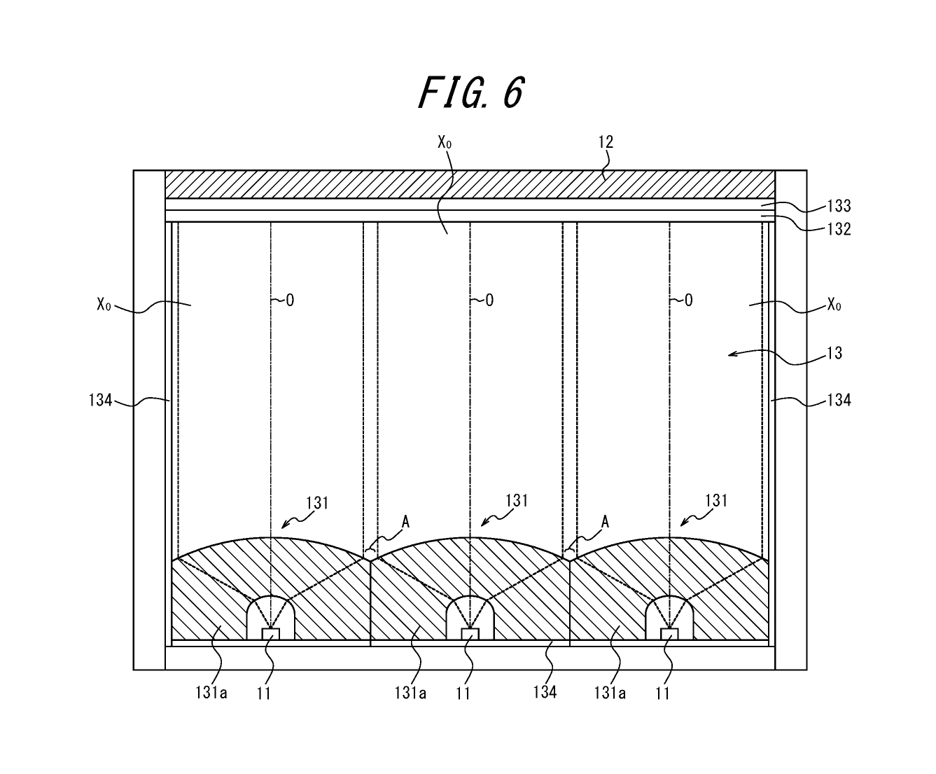

Referring to FIG. 6, a schematic configuration of another variation of the display 10 will be described. The illumination optical system 13 of the display 10 may include a reflective polarizing plate 133 and a reflection sheet 134.

The reflective polarizing plate 133 has a property to transmit specific polarized components while reflecting the other polarized components. The reflective polarizing plate 133 is positioned between the light source 11 and the display panel 12. In the example illustrated in FIG. 6, the reflective polarizing plate 133 is positioned between the diffuser plate 132 and the display panel 12. The reflective polarizing plate 133 is oriented such that a polarization direction of transmitted polarization components is aligned with a polarization direction of the polarizing filter of the display panel 12.

The reflection sheet 134 has a property to reflect light. The reflection sheet 134 may reflect the light emitted from the light source 11 including the illumination light X₀. The reflection sheet 134 is positioned on a surface of the substrate that is facing and supporting the light source 11. The reflection sheet 134 may be positioned within a frame supporting the lens module 131.

The illumination optical system 13 includes the reflective polarizing plate 133 and the reflection sheet 134. The reflective polarizing plate 133 reflects the polarized components of the illumination light X₀ other than the polarized components of the illumination light X₀ that can pass through the display panel 12. The polarized light components reflected by the reflective polarizing plate 133 are repeatedly reflected by the reflection sheet 134 before re-entering the reflective polarizing plate 133. A polarized state of the illumination light X₀ changes due to the reflection. After re-entering the reflective polarizing plate 133, a portion of the illumination light X₀ that can pass through the display panel 12 passes through the display panel 12, and the other portion is reflected. By repeating being reflected by the reflection sheet 134, the illumination light X₀ gradually passes through the reflective polarizing plate 133. In the illumination optical system 13 that includes the reflective polarizing plate 133 and the reflection sheet 134, the brightness of the display light X is increased by enhancing the use efficiency of the illumination light X₀.

Although the present disclosure has been described on the basis of the figures and the embodiments, it is to be understood that various modifications and changes may be readily implemented by those who are ordinarily skilled in the art. Accordingly, such modifications and changes are included in the scope of the present disclosure. For example, functions and the like of each element or each step can be rearranged without a logical inconsistency, such that a plurality of elements or steps are combined or divided.

Although the lens module 131 has been described as having an elliptical shape within the plane perpendicular to the optical axis O of the illumination light X₀, the lens module 131 is not limited thereto and may have, for example, a circular shape.

Although the illumination optical system 13 has been described as including a plurality of lens modules 131, the number of the lens modules 131 is not limited to a plural number and may be one.

Although each lens included in the lens module 131 has been described as having the peripheral portion A with the rough surface that faces the display panel 12 and diffuses the illumination light X₀, this configuration is not restrictive.

### REFERENCE SIGNS LIST

1 head-up display for a car
10 display
11 light source
12 display panel
13 illumination optical system
20 projection optical system
131 lens module
132 diffuser plate
133 reflective polarizing plate
134 reflection sheet
A lens peripheral portion
M operator
O optical axis of illumination light
V vehicle
X display light
X₀ illumination light
Y semi-transmissive plate
Z virtual image

1. A head-up display for a vehicle comprising:
a light source, a display panel of a transmissive type, and an illumination optical system configured to guide illumination light from the light source to the display panel, wherein
the illumination optical system includes a lens module including one or more lenses positioned on an optical axis of the illumination light,
the light source is configured to emit the illumination light in which beams forming a larger angle with respect to the optical axis have lower brightness, and
the lens module has an optical property whereby, in the illumination light beams which form a larger angle with respect to the optical axis are transmitted with increased density.

2. The head-up display for a vehicle according to claim 1,
wherein a lens included in the lens module has a concave surface facing the light source and a convex surface facing the display panel.

3. The head-up display for a vehicle according to claim 1,
wherein a lens included in the lens module has a refractive index distribution in which the refractive index increases away from the optical axis.

4. The head-up display for a vehicle according to claim 1,
wherein the lens module renders the illumination light into substantially collimated light with a uniform brightness distribution.

5. The head-up display for a vehicle according to claim 1, wherein
the illumination optical system includes a plurality of light sources and a plurality of lens modules,
each of the light sources is opposite to a corresponding one of the lens modules, and
the plurality of lens modules renders illumination light passing through each of the plurality of lens modules into substantially collimated light.

6. The head-up display for a vehicle according to claim 1, comprising:
a reflective polarizing plate positioned between the light source and the display panel; and
a reflection sheet positioned on a surface of a substrate facing and supporting the light source.
